(19) United States
(12) Patent Application Publication
(10) Pub. No.: US 2005/0041812 A1
(43) Pub. Date: Feb. 24, 2005

(54) Method and system for stateful storage processing in storage area networks

(75) Inventors: Kumar Sundararajan, Fremont, CA (US); Dharmesh Shah, San Jose, CA (US); Sanjay Sawhney, Cupertino, CA (US); Atul Pandit, Sunnyvale, CA (US); Aseem Vaid, San Jose, CA (US); Richard Moeller, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: NeoScale Systems, Inc., Milpitas, CA (US)

(21) Appl. No.: 10/688,848

(22) Filed: Oct. 17, 2003

Related U.S. Application Data
(60) Provisional application No. 60/419,655, filed on Oct. 18, 2002.

(51) Int. Cl. H04K 1/00

(52) U.S. Cl. 380/256

(57) ABSTRACT

A system (and methods) for performing a service operation on a Fibre Channel or other like channels. The system has an interface coupled to a Fibre Channel. A classifier is coupled to the interface. The classifier is adapted to receive an initiator frame from the interface. The classifier is adapted to determine header information from the initiator frame and is also adapted to determine source information, destination information, and exchange information from the header information. A flow content addressable memory is coupled to the classifier. The flow content addressable memory is configured to store one or more header information. Each of the one or more header information is associated with a state. The system has a rule content addressable memory coupled to the classifier. The rule content addressable memory is configured to store one of a plurality of policies. A processing module is coupled to the classifier. The processing module is adapted to process an incoming payload associated with the initiator frame and the header information.

### CROSS REFERENCES TO RELATED APPLICATIONS

This application claims priority to U.S. Provisional Application 60/419,655 filed Oct. 18, 2002, hereby incorporated by reference for all purposes.

### BACKGROUND OF THE INVENTION

The present invention relates generally to security in storage area networks. More particularly, the invention provides a method and system for stateful storage processing in storage area networks through a Fibre Channel. But it would be recognized that the invention has a much broader range of applicability.

Data path devices in a Storage Area Network (SAN) are deployed between servers and storage subsystems (examples of such devices are storage switches/routers or other appliances). These devices process the incoming frames on the basis of inspecting headers of individual frames. However, the frame processing in these devices is substantially stateless. These devices do not save any context information from an examined frame and then use that information in processing subsequent frames. These and other limitations are described throughout the present specification and more particularly below.

From the above, it is seen that an improved method and system for processing data in storage area network application is highly desirable.

### BRIEF SUMMARY OF THE INVENTION

According to the present invention, techniques for security in storage area networks are provided. More particularly, the invention provides a method and system for stateful storage processing in storage area networks through a Fibre Channel. But it would be recognized that the invention has a much broader range of applicability.

In a specific embodiment, the invention provides a method for performing one or more service operations on a Fibre Channel. The method includes transferring an initiator frame through a Fibre Channel interface, which is coupled to a security apparatus. Further details of the security apparatus can be found at U.S. Pat. No. ______ (Attorney Docket Number 021970-000510US), commonly assigned, and hereby incorporated by reference for all purposes. Other types of security apparatus can also be used. The method includes receiving the initiator frame (i.e., SCSI format) at the security apparatus and determining header information from the initiator frame. The method also includes extracting source information, destination information, and exchange information from the header information. At least one policy based upon at least the source information and the destination information is selected. The policy is directed to setting up at least a flow associated with the initiator frame. The method also includes associating a subsequent frame including an incoming payload with the flow associated with the initiator frame and processing an incoming payload associated with a subsequent frame and associated with the initiator frame. The method includes transferring the processed payload via the Fibre Channel.

In an alternative specific embodiment, the invention provides a method for performing a service operation on a Fibre Channel or other like channel. The method includes transferring an initiator frame through a Fibre Channel, which is coupled to a security apparatus. The method includes transferring one or more subsequent frames through the Fibre Channel after the initiator frame and receiving the initiator frame via a SCSI format through the Fibre Channel. The method also includes determining header information from the initiator frame and extracting source information, destination information, and exchange information from the header information of the initiator frame. The method performs a look up operation on a look up table using a header information on the initiator frame. The method also creates one or more flows based upon the header information of the initiator frame. At least one policy is received. The method includes associating the one or more subsequent frames with the one or more flows based upon the header information of the initiator frame and includes processing an incoming payload associated with the one or more subsequent frames. The method also transfers the processed payload of the one or more subsequent frames through the Fibre Channel.

In an alternative specific embodiment, the invention provides a system for performing a service operation on a Fibre Channel or other like channels. The system has an interface coupled to a Fibre Channel. A classifier is coupled to the interface. The classifier is adapted to receive an initiator frame from the interface. The classifier is adapted to determine header information from the initiator frame and is also adapted to determine source information, destination information, and exchange information from the header information. A flow content addressable memory is coupled to the classifier. The flow content addressable memory is configured to store one or more header information. Each of the one or more header information is associated with a state. The system has a rule content addressable memory coupled to the classifier. The rule content addressable memory is configured to store one of a plurality of policies. A processing module is coupled to the classifier. The processing module is adapted to process an incoming payload associated with the initiator frame and the header information.

Still further, the invention provides a transparent method for performing security operations on one or more Fibre Channels coupled to a communication network. The method includes transferring a frame through a Fibre Channel, which is coupled to a security apparatus. The method also includes receiving the frame at the security apparatus and determining header information from the initiator frame. The method includes extracting source information, destination information, and exchange information from the header information. The method also includes performing a look up operation on a look up table using a header information on the frame and creating one or more flows based upon the header information. The method receives at least one policy based upon at least the source information and the destination information. Next, the method processes an incoming payload (e.g., intrusion detection, attack) associated with the initiator frame and transferring the processed payload through the Fibre Channel.

Numerous benefits exist with the present invention over conventional techniques. In a specific embodiment, the invention provides a way to perform security operations at wire speed via a Fibre Channel interface. In other embodiments, the invention also provides a way to provide transparent security applications via a SCSI format for network storage applications. The invention can also be implemented using conventional software and hardware technologies. The present system and method can also be used for intrusion detection at wirespeed or other types of attacks. Preferably, the system can also be used as a proxy and be transparent to an end user by way of the wire speed processing. Depending upon the embodiment, one or more of these benefits or features can be achieved. These and other benefits are described throughout the present specification and more particularly below.

The accompanying drawings, which are incorporated in and form part of the specification, illustrate embodiments of the invention and, together with the description, serves to explain the principles of the invention.

### BRIEF DESCRIPTION OF THE DRAWINGS

FIG. 1 illustrates a frame classification and servicing method according to an embodiment of the present invention.

FIG. 2 is a simplified flowchart illustrating a process for frame classification according to an embodiment of the present invention.

### DETAILED DESCRIPTION OF THE INVENTION

According to the present invention, techniques for security in storage area networks are provided. More particularly, the invention provides a method and system for stateful storage processing in storage area networks through a Fibre Channel. But it would be recognized that the invention has a much broader range of applicability.

A system and method disclosed herein are used to process block traffic in storage networks in a stateful manner according to a specific embodiment. The stateful storage processing may be implemented in an intermediate device (e.g., by an in-band data path appliance between a server and storage subsystem) in the form of a classification driven frame processing module. The stateful storage processing method may be used for encrypting/decrypting in band media traffic payload, detecting intrusions in Fibre Channel networks, providing strong access control (including SCSI command and block range control), preventing denial of service attacks in FC SANs, and providing a fast, efficient, and flexible method of gathering I/O statistics, for example. Further details are described below.

A set of related frames, e.g. an I/O transaction, are handled as a unit for the purpose of tracking frames and storage services according to an alternative embodiment. It is to be understood that it is not necessary that the same set of services be applied to all frames in an I/O. An example is when in an intermediate device payload encryption is only applied to data frames.

A data path appliance that is architected with stateful storage processing applies a set of services defined by configured policies to each frame. A service is handled by a service module and has two parts, a filter that determines what frames are interesting for that policy, and one or more actions that should be applied to the frame to carry out the service. The filtering database for a policy is maintained by the corresponding service module. To speed up the process of classification and avoid a complete filter lookup on every frame, the concept of a flow is introduced. A flow is defined as a set of related frames, e.g. an I/O transaction, handled as a unit for the purpose of tracking frames and storage services. The classifier attempts to correlate each input frame to an existing flow. If a flow exists, the relevant services are invoked with a pointer to the corresponding flow structure. If no flow is found, the classifier checks if the frame can initiate a new flow and if it can, it creates a new flow to be used to process subsequent frames in that flow.

The following is an example of a high level view of the steps involved in processing the first frame of a flow:
Input frame→Dispatcher→Classifier→Input service processing→Classifier→Output service processing→Output frame

The interface driver passes the frame up to the dispatcher. The dispatcher invokes the classifier, which determines the set of all services that are relevant to the frame type and creates a partially established flow. The dispatcher then invokes each service in turn. As each service module is invoked, it checks its filtering database, determines if the flow is of interest and if so, retrieves any context specific information and stores it in the flow structure. If the flow is not of interest to a particular service, it returns a special value to the dispatcher, which then clears that service from the set of services. This ensures that the service will not be invoked for subsequent frames for that flow. After the last module in this chain is invoked, the dispatcher invokes the forwarding and transport module that determines the destination interface and the output transport protocol. The dispatcher then calls the classifier again to carry out any output classification.

The second classification step is required because the set of services to be applied after the frame is forwarded are not known to the classifier when it sees the first frame. The classifier only uses the flow database to classify frames and has no knowledge of the forwarding database, which is dynamic by nature. An example is an FC frame that needs to be forwarded over an IPSEC tunnel. The forwarding and transport module determines the output interface and the IP address of the peer gateway and writes the transport protocol specific encapsulation. Thus, at this stage the frame has been transformed to an IP packet. The second stage of classification is now applied to this IP packet and it is determined whether it needs to be processed by IPSEC. The IPSEC module can retrieve a pointer to the SA and store it in the flow structure.

The dispatcher then iterates through the set of service modules that carry out output processing. Once the first frame has been processed completely and sent to the output interface, the flow is fully established. This means that the flow structure, in most cases, contains all the information required to process subsequent packets without consulting the filtering/rules database. The IDs of all the services applied to the first frame are stored in the flow structure. Thus the second classification step is not needed for all subsequent frames.

The following is an example of a high level view of the steps involved in processing all subsequent frames of a flow:
Input frame→Dispatcher→Flow Classification→Input and Output service processing→Output frame

A frame can arrive at an interface either from the external line (input processing) or from the internal backplane from another interface (output processing). Thus each flow on an interface has two components, an incoming one and an outgoing one. When a new flow is recognized a corresponding flow structure, called the primary flow structure, is created. After the first frame of the flow is switched to an output interface, a corresponding flow structure, called the secondary flow structure, is created for the output interface and the two flow structures are linked together. Thus the primary flow structure models the initiator side of the transaction while the secondary flow models the responder side. The secondary flow structure is used to process frames from the responder back to the initiator.

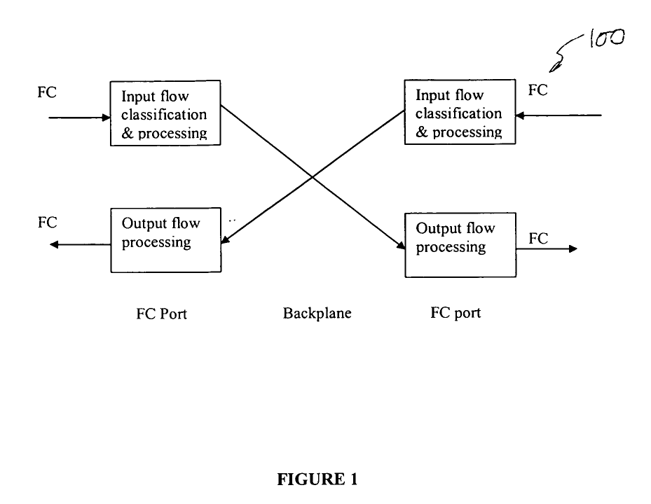

Referring to FIG. 1, which is a simplified flow 100 diagram of a method, the bulk of the classification is done when the frame arrives on an interface from the external line. This classification determines the output interface, the ID of the outgoing flow on that interface, and the set of services to be applied to that frame. After the first frame is processed, output processing does not need to perform a lookup to determine the outgoing flow. These and other processes can occur using the present method and system. Further details of the present method and system can be found throughout the specification and more particularly below.

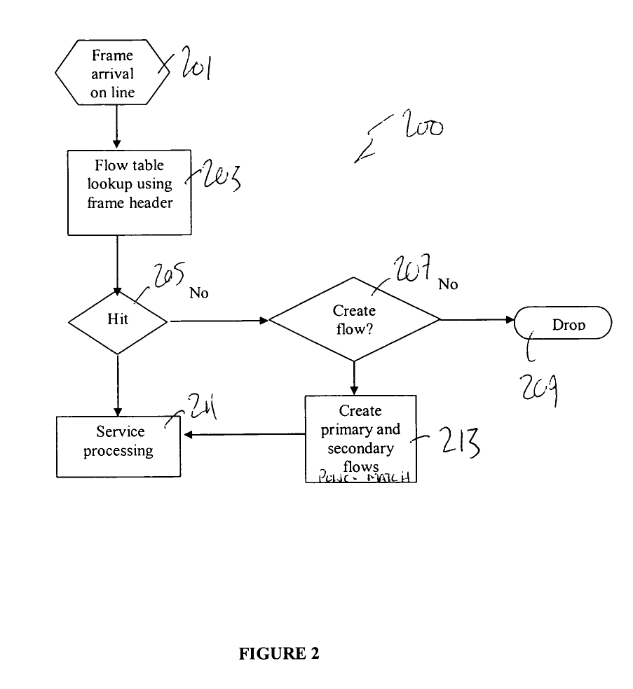

FIG. 2 is an example of a high level flowchart 200 for frame classification according to an embodiment of the present invention. This diagram is merely an example, which should not unduly limit the scope of the claims herein. One of ordinary skill in the art would recognize many variations, modifications, and alternatives. The processing steps are similar for a frame arriving over the backplane, however, the flow table lookup is not required, since the flow ID has already been determined as part of input processing.

The following provides additional details on the classification process. An FC frame destined (step 201) for the well-known FC addresses or the domain controller address (FFFFFD, FFFC {01-EF}) is directed to the management CPU/process. All other frames are classified using the flow/class tables according to preferred embodiments.

There are two kinds of FC flow tables (step 203):
FCP flow table: Tracks all FCP I/O and task management exchanges.
FC ELS and FCP FC-4 Link data flow table: Tracks FC ELS
   exchanges, e.g. PLOGI and FCP-2 FC-4 Link data exchanges, e.g. REC (Read Exchange Concise).

An FCP flow is created (step 207) when all of the following are true:
FC frame header field R_CTL routing==FC 4 Device Data: first 4 bits in byte 0 of FC header;
FC frame header field R_CTL info category==unsolicited command: last 4 bits in byte 0 of FC header; and
FC frame header field TYPE==FCP: 9th byte in FC header.
An FCP flow may be created when the following is true:
FC frame header field F_CTL.first_sequence==1, if linked commands are to be treated as one flow: bit 21 in the 3rd word in FC header.

Linked commands may or may not be treated as one flow, depending on whether the CDB is inspected.

The following is an example of a write I/O consisting of multiple frames. A typical SCSI FCP write operation with three data Information frames and using FCP_XFER_RDY is shown in Table I.

TABLE I

| Initiator function | Information Unit (IU) | Target Function |
|---|---|---|
| Command request | T1, FCP_CMND -> | [Prepare data transfer |
| | | buffer] |
| | <- I1, FCP_XFER_RDY | First data delivery |
| | | request |
| First Data Out | T6, FCP_DATA -> | Second data delivery |
| Action | <- I1, FCP_XFER_RDY | request |
| Second Data Out | T6, FCP_DATA -> | Last data delivery |
| Action | <- I1, FCP_XFER_RDY | request |
| Last Data Out | T6, FCP_DATA -> | [Prepare response |
| Action | | message] |
| | <- I4, FCP_RSP | Response |
| [Indicate command | | |
| completion] | | |

Actions are preferably based on service rules or policies and are applied to the first frame, and if a flow is created, to all subsequent frames of that flow. The actions may be one or more of the following:
Allow SCSI command and create incoming and outgoing flows (step 207, 213) on input and output ports. (More flows may be needed for specific commands if SCSI payload rewrite is required).
Disallow command (SCSI level access control) by returning SCSI Check Condition. Any subsequent frames sent by the initiator for this flow are dropped (step 209).
Proxy command. An example is LUN masking. The REPORT LUNS command has to be terminated at the gateway, the LUN list modified according to access rules and transmitted back to the initiator.
Disallow frame (FC zoning) and drop frame (F_RJT may be sent for Class2).
Return SCSI Busy response (initiator admission control)
Rewrite rules for S_ID, D_ID or LUN
Determine security actions
Determine QOS class
Forwarding—output port, IP address of next gateway, etc.
Determine output translation

Embodiments of the invention may include one or more of the following features:
a) selectively encrypt/decrypt data frames payload going to/coming from the storage subsystem;
b) selectively allow or deny access to a part of the network based on deep packet inspection (down to SCSI command and block range level);
c) track individual I/Os between the server and the storage subsystem by looking at individual frames (and maintaining I/O context across a set of related frames);
d) prevent denial of service attacks on a shared storage subsystem;
e) detect intruder accesses to the shared stored storage subsystem;
f) provide the intelligence of higher layers in the storage stack while still processing frames at Fibre Channel layer 2 (in a fast hardware data path);
g) provide a flexible programmable rule based engine in Fibre Channel network;
h) use content addressable memory (CAMs) to provide a fast lookup mechanism which does not depend on the number of security policies and rules;
i) provide a low latency architecture for an in-band appliance that transparently encrypts/decrypts storage traffic.
Depending upon the embodiment, these services (step 211) and others can be formed. Preferably, they are performed on incoming payloads from a Fibre Channel at wire speed. Certain details of a system for implementing these services are provided throughout the present specification and more specifically below.

In one embodiment, the system is implemented in a platform according to an embodiment of the present invention. The platform is a hardware platform for line-rate (1 G) FC frame classification and services. The services include media encryption, transport encryption on Fibre Channel, strong access control, statistics and differentiated class of service (COS). Further details of the present system are described throughout the present specification and more particularly below.

The system has four action processors to implement various services. Two of these, the Security Action Processors (SAP1 and SAP2) carry out Security services, namely, media encryption, transport encryption on Fibre Channel. The Generic Action Processor (GAP) handles frame filtering and COS assignment. The Statistics processor collects statistics based on configured rules. The statistics data is periodically collected by software for export.

The system uses a CAM-based classifier to classify frames. An incoming frame is first looked up in the flow CAM. If a match is found, the CAM index is used to lookup a flow context RAM to get the indexes of the rules that need to be applied to the frame. If the frame is a flow terminator, the flow is deleted after the frame is looked up. If a match is not found in the flow CAM and the frame is a flow initiator, a flow is automatically created and lookups are carried out on the rule CAM. The rule CAM is divided into four parts, one for each of the action processors and a lookup is done for each part. The results of the four rule CAM lookups are stored in the flow context RAM for further flow processing.

GAP actions can be invoked at three points in the data path. The first one is after the first classification stage, the second one after the second classification (i.e. post transport encryption classification) stage and the third one after the second SAP. A different context RAM is associated with each invocation point. The three GAP invocation points are named GAP1, GAP2 and GAP3.

The present system classifies each frame into one of eight groups for the purpose of COS and in-order delivery. The COS value is used to implement priority-based output scheduling. Within each group, frames are transmitted in the same order as they are received.

Preferably, the system uses 2 Mb CAM. It is configured so that one portion of the CAM is used for flows, and the other one for rules. If divided equally, this will support up to 8K flows and 4K rules. The rule space can be divided among the four service rule groups in any manner. Priority among matches is according to physical address, with lower addresses having higher priority. As noted, further details of the present system can be found at U.S. Pat. No. ______ (Attorney Docket Number 021970-000510US), commonly assigned, and hereby incorporated by reference for all purposes.

Although the present invention has been described in accordance with the embodiments shown, one of ordinary skill in the art will readily recognize that there could be variations made to the embodiments without departing from the scope of the present invention. Accordingly, it is intended that all matter contained in the above description and shown in the accompanying drawings shall be interpreted as illustrative and not in a limiting sense.

1. A method for performing one or more service operations on a Fibre Channel, the method comprising:
transferring an initiator frame through a Fibre Channel, the Fibre Channel being coupled to a security apparatus;
receiving the initiator frame via a Fibre Channel interface at the security apparatus; determining header information from the initiator frame;
extracting source information, destination information, and exchange information from the header information;
retrieving at least one policy based upon at least the source information and the destination information, the policy being directed to setting up at least a flow associated with the initiator frame;
associating a subsequent frame including an incoming payload with the flow associated with the initiator frame;
processing an incoming payload associated with a subsequent frame and associated with the initiator frame; and
transferring the processed payload through the Fibre Channel.

2. The method of claim 1 wherein the policy is one of a plurality of policies stored in a rule database.

3. The method of claim 1 wherein the policy is one of a plurality of policies stored in a rule content addressable module, the content addressable module being a content addressable memory.

4. The method of claim 1 wherein the service is a security operation.

5. The method of claim 1 wherein the initiator frame is associated with a read request and the policy is associated with a decryption process.

6. The method of claim 1 wherein the initiator frame is associated with a write request and the policy is associated with an encryption process.

7. The method of claim 1 wherein the policy is associated with an access control process.

8. The method of claim 1 wherein the policy is associated with a statistics process.

9. The method of claim 1 wherein the policy is associated with a transport policy.

10. The method of claim 1 wherein the processing is provided on a security action processor.

11. A method for performing a service operation on a Fibre Channel, the method comprising:
transferring an initiator frame through a Fibre Channel, the Fibre Channel being coupled to a security apparatus;
transferring one or more subsequent frames through the Fibre Channel after the initiator frame;
receiving the initiator frame via a SCSI format through the Fibre Channel;
determining header information from the initiator frame;
extracting source information, destination information, and exchange information from the header information of the initiator frame;
performing a look up operation on a look up table using a header information on the initiator frame;
creating one or more flows based upon the header information of the initiator frame; and
retrieving at least one policy based upon at least information in the header information;
associating the one or more subsequent frames with the one or more flows based upon the header information of the initiator frame;
processing an incoming payload associated with the one or more subsequent frames for at least intrusion detection; and
transferring the processed payload of the one or more subsequent frames through the Fibre Channel.

12. The method of claim 1 wherein the processing of the incoming payload is provided at wire speed.

13. The method of claim 1 wherein the processing of the incoming payload is at a speed of greater than 1 Gigabit per second.

14. The method of claim 1 wherein the look up table is provided in a flow content addressable memory.

15. The method of claim 4 wherein the processing of the incoming payload is provided at wirespeed, the processing comprising an encryption or a decryption process.

16. A system for performing a service operation on a Fibre Channel, the system comprising:
an interface coupled to a Fibre Channel;
a classifier coupled to the interface, the classifier being adapted to receive an initiator frame from the interface; the classifier being adapted to determine header information from the initiator frame and being adapted to determine source information, destination information, and exchange information from the header information;
a flow content addressable memory coupled to the classifier, the flow content addressable memory being configured to store one or more header information, each of the one or more header information being associated with a state;
a rule content addressable memory coupled to the classifier, the rule content addressable memory being configured to store one of a plurality of policies; and
a processing module coupled to the classifier, the processing module being adapted to process an incoming payload associated with the initiator frame and the header information.

17. The system of claim 1 further comprising a statistics processor coupled to the classifier.

18. The system of claim 1 further comprising a generic action processor coupled to the classifier.

19. A transparent method for performing security operations on one or more Fibre Channels coupled to a communication network, the method comprising:
transferring a frame through a Fibre Channel, the Fibre Channel being coupled to a security apparatus;
receiving the frame at the security apparatus;
determining header information from the initiator frame;
extracting source information, destination information, and exchange information from the header information;
performing a look up operation on a look up table using a header information on the frame;
creating one or more flows based upon the header information; and
retrieving at least one policy based upon at least the source information and the destination information;
processing an incoming payload associated with the initiator frame, the payload being derived from one or more subsequent frames; and
transferring the processed payload through the Fibre Channel.

20. The method of claim 1 wherein the processing of the incoming payload is provided at wire speed.

21. The method of claim 1 wherein the processing of the incoming payload is at a speed of greater than 1 Gigabit per second.

22. The method of claim 1 wherein the look up table is provided in a flow content addressable memory.

23. The method of claim 4 wherein the flow content addressable memory is provided with a predetermined size.

24. The method of claim 1 wherein the incoming payload is provided on a responder frame.

25. The method of claim 1 wherein the processing of the incoming payload is based upon the flow that was based upon the header information.

26. The method of claim 1 wherein the processing is performed using at least the one policy.
